(19) United States
(12) Patent Application Publication
(10) Pub. No.: US 2025/0371234 A1
(43) Pub. Date: Dec. 4, 2025

(54) Central Processing Unit Turbo Yield Boosting Method and System Based on an Explainable Artificial Intelligence Framework

(71) Applicant: MEDIATEK INC., Hsinchu City (TW)

(72) Inventors: Chin-Wei Lin, Hsinchu City (TW); Po-Chao Tsao, Hsinchu City (TW); Chi-Ming Lee, Hsinchu City (TW); Khim Jun Koh, Hsinchu City (TW); Yi-Ju Ting, Hsinchu City (TW); Hsin-Hsin Hsiao, Hsinchu City (TW); Chin-Tang Lai, Hsinchu City (TW); Tung-Hsing Lee, Hsinchu City (TW)

(73) Assignee: MEDIATEK INC., Hsinchu City (TW)

(21) Appl. No.: 19/200,732

(22) Filed: May 7, 2025

Related U.S. Application Data
(60) Provisional application No. 63/655,667, filed on Jun. 4, 2024.

(51) Int. Cl. G06F 30/333; G06F 30/27; G06F 119/06; G06F 119/22

(52) U.S. Cl. CPC G06F 30/333; G06F 30/27; G06F 2119/06; G06F 2119/22

(57) ABSTRACT

A central processing unit (CPU) turbo yield boosting method includes acquiring a plurality of Wafer Acceptance Test (WAT) parameters from a foundry, acquiring a CPU turbo yield from a final test stage, generating a predicted CPU turbo yield for the plurality of WAT parameters using a training model based on the plurality of WAT parameters and the CPU turbo yield, and generating a plurality of importance values corresponding to the plurality of WAT parameters using a WAT importance analysis module based on the predicted CPU turbo yield and the plurality of WAT parameters. The training model and the WAT importance analysis module are integrated into an explainable Artificial Intelligence (AI) framework.

### BACKGROUND

In the semiconductor manufacturing field, enhancing Central Processing Unit (CPU) turbo yield, which means attaining higher frequency at the same power consumption, is a vital goal. Traditionally, this has been approached by employing methods such as the Pearson coefficient square (R-square) to find the WAT (Wafer Acceptance Test) items most related to CPU turbo yield, and then changing those WAT items. However, this conventional method has significant limitations. For example, the Pearson method of processing the WAT items often resulted in low R-square values with a diverging distribution, showing a weak association between the selected WAT items and the CPU turbo yield.

A concrete case highlights this dilemma. When modifying an on-current of the WAT items on standard R-square analysis, it was discovered that raising the on-current did not assist in improving turbo yield. In certain circumstances, it even led to a fall in turbo yield due to power consumption limits. Furthermore, the conventional technique may fail to identify WAT items that genuinely have a substantial contribution to CPU turbo yield. These limitations reveal that the conventional method is not always efficient in finding the WAT items that genuinely influence CPU turbo yield, leading to poor modifications and potentially impeding efforts to improve output.

### SUMMARY

In an embodiment, a central processing unit (CPU) turbo yield boosting method is disclosed. The CPU turbo yield boosting method comprises acquiring a plurality of Wafer Acceptance Test (WAT) parameters from a foundry, acquiring a CPU turbo yield from a final test (FT) stage, generating a predicted CPU turbo yield for the plurality of WAT parameters using a training model based on the plurality of WAT parameters and the CPU turbo yield, and generating a plurality of importance values corresponding to the plurality of WAT parameters using a WAT importance analysis module based on the predicted CPU turbo yield and the plurality of WAT parameters. The training model and the WAT importance analysis module are integrated into an explainable Artificial Intelligence (AI) framework.

In another embodiment, a CPU turbo yield boosting system is disclosed. The CPU turbo yield boosting system comprises a data collection module, a memory linked to the data collection module and configured to store a training model, and a processor linked to the memory and configured to perform a WAT importance analysis module and the training model. The data collection module acquires a plurality of WAT parameters from a foundry. The data collection module acquires a CPU turbo yield from an FT stage. The training model generates a predicted CPU turbo yield for the plurality of WAT parameters based on the plurality of WAT parameters and the CPU turbo yield. The training model generates a plurality of importance values corresponding to the plurality of WAT parameters based on the predicted CPU turbo yield and the plurality of WAT parameters. The training model and the WAT importance analysis module are integrated into an explainable AI framework.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a central processing unit (CPU) turbo yield boosting system according to an embodiment of the present invention.

FIG. 2 is a schematic diagram of performing the training model of the CPU turbo yield boosting system in FIG. 1.

FIG. 3 is a schematic diagram of performing the Wafer Acceptance Test importance analysis module of the CPU turbo yield boosting system in FIG. 1.

FIG. 4 illustrates the explainable WAT importance results of the CPU turbo yield boosting system in FIG. 1.

FIG. 5 is a flow chart of performing the CPU turbo yield boosting method by the CPU turbo yield boosting system in FIG. 1.

### DETAILED DESCRIPTION

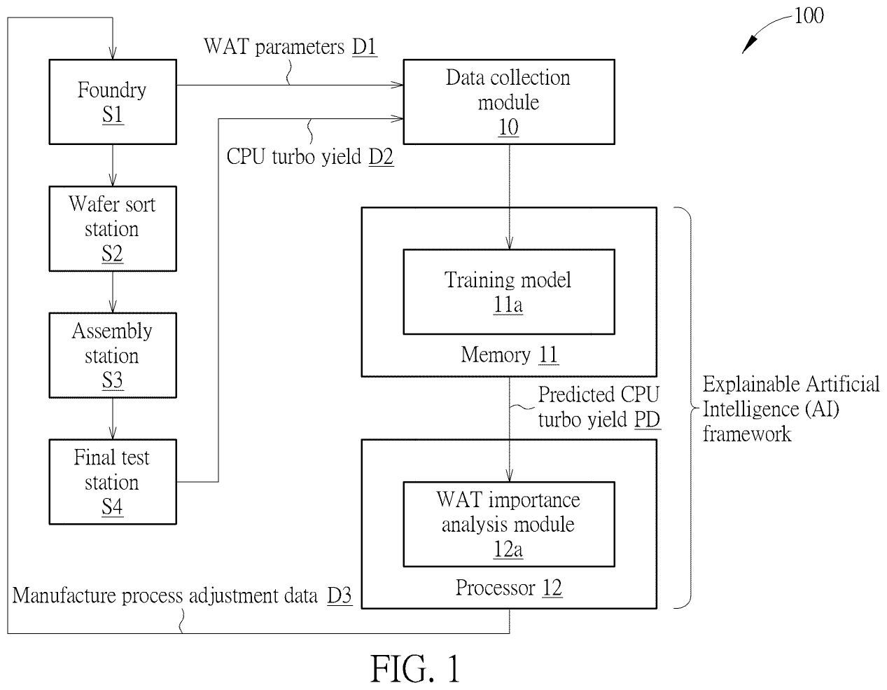

FIG. 1 is a block diagram of a central processing unit (CPU) turbo yield boosting system 100 according to an embodiment of the present invention. The CPU turbo yield boosting system 100 solves the issues in improving CPU turbo yield during the manufacturing process. In one embodiment, the CPU turbo yield boosting system 100 leverages an Explainable Artificial Intelligence (XAI) framework to assess Wafer Acceptance Test (WAT) parameters and CPU turbo yield, providing a more accurate identification of which WAT items significantly affect the turbo yield. The CPU turbo yield boosting system 100 can detect the exact WAT items that, when adjusted, can contribute to a tangible improvement in CPU turbo yield. This is achieved by importance analysis, which identifies the degree to which each WAT item affects CPU turbo yield. By integrating AI, the CPU turbo yield boosting system 100 provides a more effective technique for determining essential WAT factors and their impact on CPU turbo yield.

In FIG. 1, the CPU turbo yield boosting system 100 includes a data collection module 10, a memory 11, and a processor 12. The data collection module 10 is designed to gather various types of data related to the wafer manufacturing process. In the embodiment, the data collection module 10 collects WAT parameters D1 and the CPU turbo yield D2. The WAT parameters D1 are measurements taken during the wafer manufacturing phase in the foundry S1. For example, the WAT parameters D1 include saturation current parameters, off-current parameters, threshold voltage parameters, effective capacitance parameters, ring oscillator speed parameters, quiescent current parameters, sheet resistance parameters, and/or contact resistance parameters, used in the process of manufacturing integrated circuits, specifically CPUs. The CPU turbo yield D2 refers to the performance metrics of the CPU after the final test stage S4. It represents the proportion of CPUs that successfully achieve turbo frequency. The CPU turbo yield D2 is crucial for evaluating the effectiveness of the manufacturing process and for training the AI model to predict and optimize CPU performance. In FIG. 1, the wafer manufacturing process is illustrated below. In the foundry S1, it can be regarded as an initial stage where the fabrication of wafers takes place. In the wafer sort station S2, the wafers undergo testing to measure electrical parameters. This is also known as Wafer Acceptance Test (WAT). In the assembly station S3, individual dies are separated from the wafer and packaged. In the final test station S4, the assembled CPUs of wafers undergo rigorous testing to ensure they meet quality and performance standards. CPU turbo yield D2 is measured at this station.

The memory 11 is linked to the data collection module 10 for storing a training model 11a. In the embodiment, the memory 11 can be used to store data and instructions necessary for the system's operation, such as the Explainable Artificial Intelligence (XAI) framework. The training model 11a can be an extreme Gradient Boosting (XGBoost) model, a light Gradient Boosting Machine (LightGBM) model, a categorical boosting (CatBoost) model, or a random forest model. The processor 12 is linked to the memory 11 for performing a WAT importance analysis module 12a and the training model 11a. The WAT importance analysis module 12a is designed to dissect the factors influencing CPU turbo yield D2. In an embodiment, after the training model 11a outputs the predicted CPU turbo yield PD, the WAT importance analysis module 12a assesses the contribution of each WAT item to the predicted CPU turbo yield PD. For example, by applying approaches such as Shapley Additive Explanations (SHAP), the WAT importance analysis module 12a quantifies each WAT item's contribution to the predicted CPU turbo yield PD, thereby offering a clear knowledge of their respective impacts.

In the CPU turbo yield boosting system 100, the data collection module 10 acquires the plurality of WAT parameters D1 from the foundry S1. Further, the data collection module 10 acquires the CPU turbo yield D2 from the final test (FT) stage. The training model 11a generates the predicted CPU turbo yield PD for the plurality of WAT parameters D1 based on the plurality of WAT parameters D1 and the CPU turbo yield D2. Then, the training model 11a generates a plurality of importance values corresponding to the plurality of WAT parameters D1 based on the predicted CPU turbo yield PD and the plurality of WAT parameters D1. The training model 11a and the WAT importance analysis module 12a are integrated into an explainable Artificial Intelligence (XAI) framework. As previously mentioned, the XAI framework is designed to identify the WAT items that, when adjusted, can contribute to a tangible improvement in CPU turbo output. As a result, after the WAT parameters D1 are analyzed by the XAI framework, at least one WAT parameter with a high importance value can be adjusted as manufacture process adjustment data D3 for enhancing the CPU turbo yield of the wafer manufacturing process.

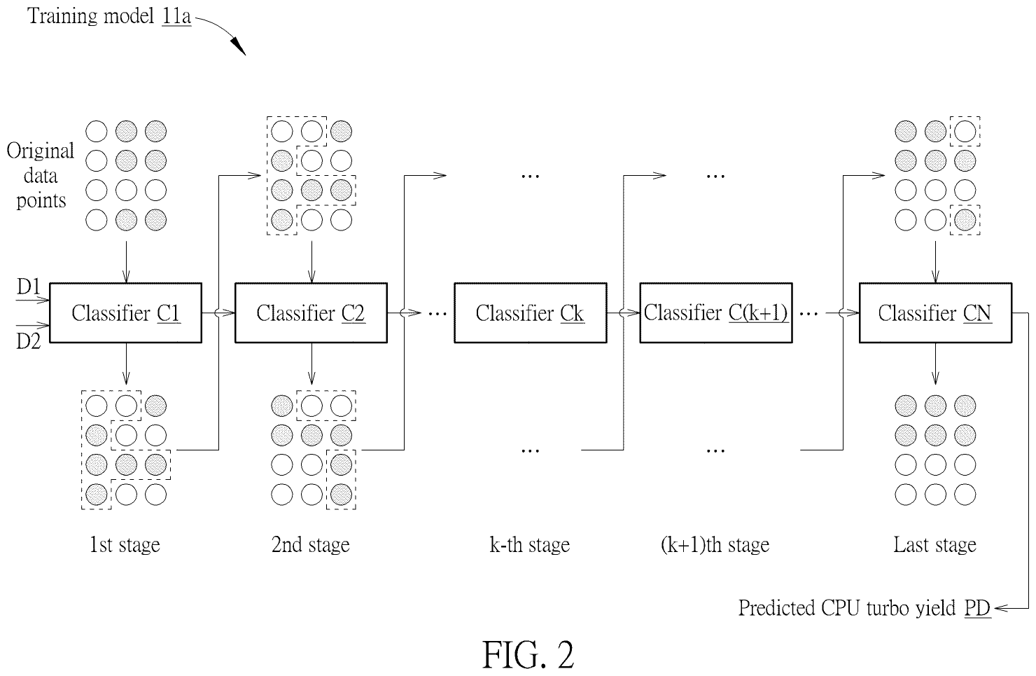

FIG. 2 is a schematic diagram of performing the training model 11a of the CPU turbo yield boosting system 100. For simplicity, the training model 11a is explained as the XGBoost model hereafter. The XGBoost model comprises a plurality of classifiers C1 to CN. The classifiers C1 to CN are linked in series for receiving the plurality of WAT parameters D1 and the CPU turbo yield D2. N is a positive integer. In FIG. 2, it should be understood that the XGBoost model is an ensemble learning method that integrates predictions from individual classifiers C1 to CN to make a final prediction. Each classifier in the series enhances the accuracy of the prediction of CPU turbo yield. For example, in the XGBoost mode, when the machine learning is performed, a classifier can be regarded as an algorithm of decision trees that categorizes input data into predefined classes. By using the classifiers C1 to CN, the XGBoost model can combine the predictions of “weak learners” (individual classifiers) to create a more accurate and robust “strong learner”. In the embodiment, the XGBoost model is performed by learning from the original data (based on the WAT parameters D1 and the CPU turbo yield D2), adjusting weights, and correcting errors committed by prior classifiers. Details of operations of the XGBoost model are illustrated below.

In FIG. 2, in the first stage, the “original data points” represent an initial set of data used to begin the classification process. These data points are depicted as circles, and their arrangement provides the starting point for the model's iterative learning. The number of “original data points” is determined by the number of data samples used for training the XGBoost model. Each circle corresponds to a single data sample. For instance, if 12 wafers are introduced, there will be 12 circles. Further, the number of data points isn't fixed. It depends on the dataset's size. In FIG. 2, the black circles symbolize data points that belong to one category, such as CPU turbo yield being “good” or “high”. Conversely, the white circles represent data points that belong to another category, such as CPU turbo yield being “bad” or “low”. In other words, a basic visual representation of original data points is provided by categorizing all data points into two groups as black and white circles. Then, the original data points are inputted to the classifier C1. The classifier C1 considers the underlying features of these data points. In the purpose of CPU turbo yield prediction, these features would be the WAT parameters D1. The classifier C1 analyzes these WAT parameters D1 associated with each data point (each circle). Further, based on its analysis, the classifier C1 makes an initial attempt to divide the data points into different categories. It aims to find a pattern or rule that distinguishes the black circles (e.g., high turbo yield) from the white circles (e.g., low turbo yield). For example, the classifier C1 applies a specific rule or criterion to separate the data points. This could involve, for instance, a decision rule that checks if the CPU turbo yield D2 of each data point is above or below a threshold under the WAT parameters D1. Then, the classifier C1 generates an output that indicates its classification of each data point. This output may not be perfect, meaning some black circles may be misclassified as white circles, and vice versa. In the first stage, circles inside a dashed line region represent the misclassified data points.

Further, the misclassified data points in the first stage get high weightings by the XGBoost model. By assigning higher weightings to the misclassified data points, the XGBoost algorithm places greater emphasis on the misclassified data points after performing the first stage. This technique forces the model to “pay more attention” to the data points it struggled with in the previous iteration. After the misclassified data points are weighted, the data points of the first stage are inputted to the next classifier in the series (e.g., the classifier C2). The classifier C2 further divides the data points into different categories. Similarly, the classifier C2 aims to find a pattern or rule that distinguishes the black circles (e.g., high turbo yield) from the white circles (e.g., low turbo yield). Then, in the second stage, the classifier C2 generates an output that indicates its classification of each data point. This output might not be perfect, meaning some black circles might be misclassified as white circles, and vice versa. In the second stage, circles with a dashed line region represent the misclassified data points. Further, the misclassified data points in the second stage get high weightings by the XGBoost model. By assigning higher weightings to the misclassified data points, the XGBoost algorithm places greater emphasis on the misclassified data points after performing the second stage. After the misclassified data points are weighted, the data points of the second stage are inputted to the next classifier in the series (e.g., the classifier C3), and so on.

In general, the XGBoost model acquires k-th stage data, including a plurality of data points representing samples of wafers with the high CPU turbo yield and the low CPU turbo yield. The k-th stage data is input to a k-th classifier Ck of the XGBoost model. Based on a plurality of WAT parameters D1 and the CPU turbo yield D2, the k-th classifier Ck classifies the plurality of data points of the k-th stage data into a high CPU turbo yield set and a low CPU turbo yield set. Subsequently, the XGBoost model adjusts the weightings of at least one misclassified data point within the k-th stage data to generate (k+1)th stage data. The (k+1)th stage data is input to a (k+1)th classifier C (k+1) of the XGBoost model. The k-th classifier is linked to the (k+1)th classifier. Finally, in the last stage (N-th stage), the N classifier CN outputs the last stage data points. In one embodiment, the last stage data points are partitioned into two groups without misclassification. In another embodiment, the number of misclassified data points of the last stage data points is smaller than a threshold. The threshold is set to determine whether the XGBoost model is fully trained. Upon the XGBoost model being fully trained, the XGBoost model achieves a satisfactory level of performance and is capable of outputting the predicted CPU turbo yield PD.

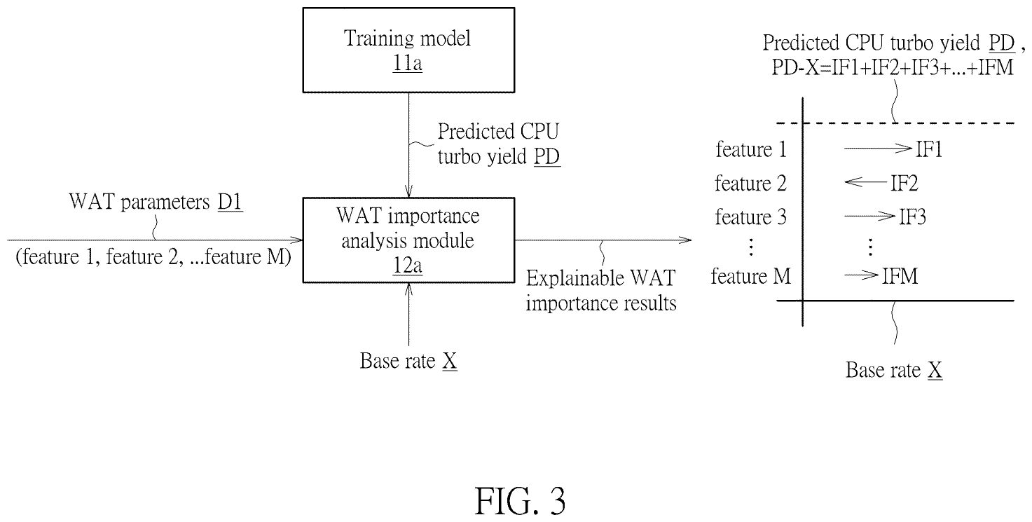

FIG. 3 is a schematic diagram of performing the WAT importance analysis module 12a of the CPU turbo yield boosting system 100. The WAT importance analysis module 12a can be a Shapley Additive Explanations (SHAP) module. The WAT importance analysis module 12a is designed to analyze the contribution of each WAT parameter to the CPU turbo yield. As previously mentioned, the training model 11a, in the embodiment, is the XGBoost model, which is trained using WAT parameters D1 and CPU turbo yield data D2. The XGBoost model outputs a predicted CPU turbo yield PD. Subsequently, the WAT importance analysis module 12a employs a method, such as SHAP, to quantify the contribution or importance of each individual WAT parameter. Feature 1 to feature M represent features of the WAT parameters D1 used as inputs for the WAT importance analysis module 12a. M is a positive integer. Base rate X represents the average CPU turbo yield across a set of wafers before the application of the XAI framework analysis. The base rate X serves as a baseline for comparison when assessing the impact of individual WAT parameters on the predicted CPU turbo yield. For instance, if the CPU turbo yield is expressed as a percentage, the base rate X would represent the average percentage yield of a group of wafers, such as 80%. In other words, the base rate X provides a starting point from which the contribution of each WAT parameter can be evaluated.

In one embodiment, the predicted CPU turbo yield PD is 90%. The base rate X is 80%. It can be derived that the aggregate contribution of all WAT parameters is 10%. In FIG. 3, IF1 denotes a first contribution score of the feature 1 of WAT parameters D1. IF2 denotes a second contribution score of the feature 2 of WAT parameters D1, and so on. IFM denotes the M-th contribution score of the feature M of WAT parameters D1. Specifically, the contribution score of the WAT importance analysis can be either positive or negative. For example, a positive contribution score for a WAT parameter indicates that “increasing” the value of the WAT parameter is associated with an increase in the predicted CPU turbo yield. Conversely, a negative contribution score indicates that “decreasing” the value of the WAT parameter is associated with an increase in the predicted CPU turbo yield. In the embodiment, the first contribution score IF1 is positive. The second contribution score IF2 is negative. The third contribution score IF3 is positive. The M-th contribution score IM3 is positive. The arrows in FIG. 3 indicate polarities of the contribution scores of features 1 to M with respect to the predicted CPU turbo yield PD. A rightward-pointing arrow signifies a positive contribution score, while a leftward-pointing arrow indicates a negative contribution score. In FIG. 3, correlations of the predicted CPU turbo yield PD, the base rate X, and contribution scores IF1 to IFM can be expressed below.

$$PD - X = IF 1 + IF 2 + ⋯ IFM$$

In brief, the WAT importance analysis module 12a acquires the base rate X of the CPU turbo yield. The WAT importance analysis module 12a receives the plurality of WAT parameters D1 and the predicted CPU turbo yield PD. The WAT importance analysis module 12a generates a gap rate (PD-X) between the predicted CPU turbo yield PD and the base rate X of the CPU turbo yield. The base rate X of the CPU turbo yield is an average CPU turbo yield for all testing wafers of the foundry. Based on the WAT parameter D1, the predicted CPU turbo yield PD, and the base rate X, the WAT importance analysis module 12a can output the explainable WAT importance results. For example, the contribution scores IF1 to IFM of the feature 1 to feature M are generated by the WAT importance analysis module 12a. Then, the WAT importance values can be defined as the absolute values of contribution scores IF1 to IFM.

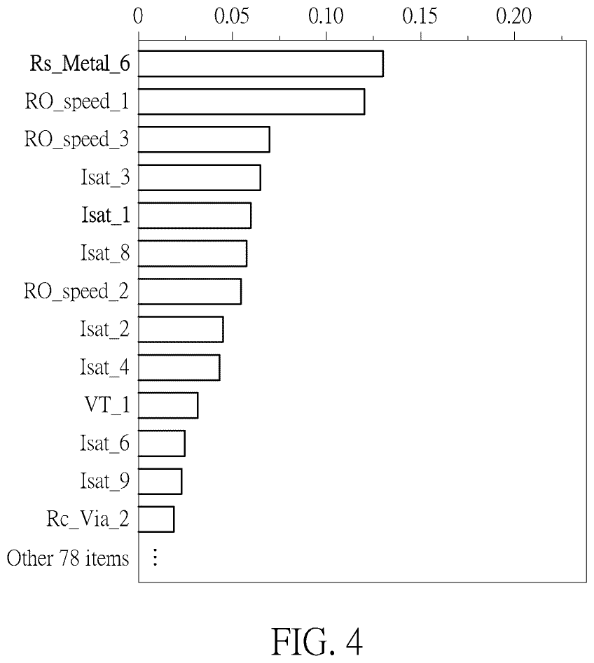

FIG. 4 illustrates the explainable WAT importance results of the CPU turbo yield boosting system. In detail, FIG. 4 illustrates the ranking of WAT parameters based on their importance values in the CPU turbo yield prediction model, as determined by the XAI framework. This ranking visually represents the contribution of each WAT parameter to the predicted CPU turbo yield, providing a clear understanding of the key factors influencing CPU performance. FIG. 4 represents WAT parameters on the y-axis, arranged in descending order of their importance values. The x-axis represents the WAT importance value, quantifying the influence of each parameter on the CPU turbo yield prediction. As shown in FIG. 4, Rs_Metal_6 (sheet resistance of metal layer 6) is identified as the WAT parameter with the highest importance value, indicating that it has the most significant impact on the CPU turbo yield prediction XAI model's output. Following Rs_Metal_6, the parameters RO_speed_1 (Ring Oscillator speed parameter 1), RO_speed_3, Isat_3 (saturation current parameter 3), and Isat_1 are ranked in descending order of importance. This representation of WAT parameter importance in FIG. 4 is generated by the XAI framework, which integrates the training model 11a (such as the XGBoost model) and the WAT importance analysis module 12a (such as SHAP). The XAI framework enables a more accurate and explainable analysis of the factors contributing to CPU turbo yield, compared to traditional methods that rely on correlation analysis alone. The importance values derived from the XAI framework provide insights into the actual impact of each WAT parameter on the predicted CPU turbo yield. In other words, the WAT importance analysis module 12a can analyze the gap rate and features of the plurality of WAT parameters to generate the plurality of importance values corresponding to the plurality of WAT parameters. The plurality of importance values are used to quantify contributions of the WAT parameters to the CPU turbo yield.

Further, a WAT parameter having the highest importance value is selected from the plurality of WAT parameters after the plurality of WAT parameters are ranked. The WAT parameter having the highest importance value is adjusted to boost the CPU turbo yield. For example, in FIG. 4, Rs_Metal_6 can be selected to optimize the CPU turbo yield. In one embodiment, the CPU turbo yield distribution is evaluated at four different Rs_Metal_6 settings: −1σ, Ref, +1σ, and +2σ. Adjusting Rs_Metal_6 downwards by one standard deviation (−1σ) results in a 7% decrease in CPU turbo yield, indicating a negative impact on performance when Rs_Metal_6 is reduced. Conversely, increasing Rs_Metal_6 leads to improved CPU turbo yield. An 8% CPU turbo yield improvement is observed when Rs_Metal_6 is adjusted upwards by one standard deviation (+1σ). A more substantial improvement of 15% is achieved when Rs_Metal_6 is increased by two standard deviations (+2σ). Experimental results demonstrate that adjusting Rs_Metal_6, identified as the most important WAT item, leads to a substantial improvement in CPU turbo yield.

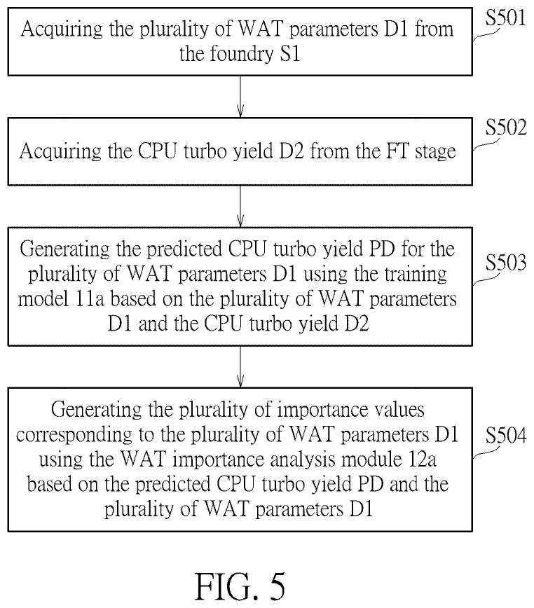

FIG. 5 is a flow chart of performing the CPU turbo yield boosting method by the CPU turbo yield boosting system 100. The CPU turbo yield boosting method includes steps S501 to S504. Any hardware or technology modification falls into the scope of the embodiments. Steps S501 to S504 are illustrated below.
Step S501: acquiring the plurality of WAT parameters D1 from the foundry S1;
Step S502: acquiring the CPU turbo yield D2 from the FT stage;
Step S503: generating the predicted CPU turbo yield PD for the plurality of WAT parameters D1 using the training model 11a based on the plurality of WAT parameters D1 and the CPU turbo yield D2;
Step S504: generating the plurality of importance values corresponding to the plurality of WAT parameters D1 using the WAT importance analysis module 12a based on the predicted CPU turbo yield PD and the plurality of WAT parameters D1.

Details of step S501 to step S504 are previously illustrated. Thus, they are omitted here. By using the XAI frame work, the CPU turbo yield boosting system 100 provides a more effective technique for determining essential WAT parameters and their impact on CPU turbo yield. The XAI framework includes the training model 11a (such as the XGBoost model) and the WAT importance analysis module 12a (such as the SHAP) for predicting the CPU turbo yield and analyzing the contribution of each WAT parameter. The CPU turbo yield boosting method enables the identification and adjustment of specific WAT items having high importance values, leading to tangible improvements in CPU turbo yield.

In summary, the aforementioned embodiments disclose a CPU turbo yield boosting system and a CPU turbo yield boosting method. The CPU turbo yield boosting system centers on employing an XAI framework to more effectively boost CPU turbo yield. The idea lies in accurately identifying and leveraging key WAT parameters that have the highest contribution to CPU turbo yield. The XAI framework includes the training model (such as the XGBoost model) and the WAT importance analysis module (such as the SHAP) for predicting the CPU turbo yield and analyzing the contribution of each WAT parameter. Compared to traditional methodologies that rely on correlation analysis (e.g., Pearson coefficient square), the CPU turbo yield boosting system of the embodiments offers advantages of providing a more precise determination of WAT parameter importance, enabling targeted adjustments that lead to tangible improvements in CPU turbo yield. Therefore, the applicable scope of the CPU turbo yield boosting system spans the semiconductor manufacturing field, and can be extended to any scenario requiring the optimization of complex manufacturing processes based on multiple parameters.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A central processing unit (CPU) turbo yield boosting method comprising:
acquiring a plurality of Wafer Acceptance Test (WAT) parameters from a foundry;
acquiring a CPU turbo yield from a final test (FT) stage;
generating a predicted CPU turbo yield for the plurality of WAT parameters using a training model based on the plurality of WAT parameters and the CPU turbo yield; and
generating a plurality of importance values corresponding to the plurality of WAT parameters using a WAT importance analysis module based on the predicted CPU turbo yield and the plurality of WAT parameters;
wherein the training model and the WAT importance analysis module are integrated into an explainable Artificial Intelligence (AI) framework.

2. The method of claim 1, wherein the plurality of WAT parameters comprise saturation current parameters, off-current parameters, threshold voltage parameters, effective capacitance parameters, ring oscillator speed parameters, quiescent current parameters, sheet resistance parameters, and/or contact resistance parameters.

3. The method of claim 1, wherein the training model is an extreme Gradient Boosting (XGBoost) model, the XGBoost model comprises a plurality of classifiers, the plurality of classifiers are linked in series and configured to receive the plurality of WAT parameters and the CPU turbo yield.

4. The method of claim 3, further comprising:
acquiring k-th stage data comprising a plurality of data points representing samples of wafers with a high CPU turbo yield and a low CPU turbo yield;
inputting the k-th stage data to a k-th classifier of the XGBoost model; and
classifying the plurality data points of the k-th stage data into a high CPU turbo yield set and a low CPU turbo yield set by the k-th classifier based on the plurality of WAT parameters and the CPU turbo yield.

5. The method of claim 4, further comprising:
adjusting weightings of at least one misclassified data point of the k-th stage data by the XGBoost model to generate (k+1)th stage data; and
inputting the (k+1)th stage data to a (k+1)th classifier of the XGBoost model;
wherein the k-th classifier is linked to the (k+1)th classifier.

6. The method of claim 5, further comprising:
outputting the predicted CPU turbo yield based on last stage data when an amount of misclassified data points of the last stage data is smaller than a threshold;
wherein the threshold is set to determine whether the XGBoost model is fully trained.

7. The method of claim 1, wherein the training model is an extreme Gradient Boosting (XGBoost) model, a light Gradient Boosting Machine (LightGBM) model, a categorical boosting (CatBoost) model, or a random forest model.

8. The method of claim 1, wherein the WAT importance analysis module is a Shapley Additive Explanations (SHAP) module, and the method further comprises:
acquiring a base rate of the CPU turbo yield;
receiving the plurality of WAT parameters and the predicted CPU turbo yield by the WAT importance analysis module; and
generating a gap rate between the predicted CPU turbo yield and the base rate of the CPU turbo yield;
wherein the base rate of the CPU turbo yield is an average CPU turbo yield for all testing wafers of the foundry.

9. The method of claim 8, further comprising:
analyzing the gap rate and features of the plurality of WAT parameters to generate the plurality of importance values corresponding to the plurality of WAT parameters using the WAT importance analysis module;
wherein the plurality of importance values are used to quantify contributions of the WAT parameters to the CPU turbo yield.

10. The method of claim 1, further comprising:
ranking the plurality of importance values corresponding to the plurality of WAT parameters;
selecting a WAT parameter having a highest importance value from the plurality of WAT parameters after the plurality of WAT parameters are ranked; and
adjusting the WAT parameter having the highest importance value to boost the CPU turbo yield.

11. A central processing unit (CPU) turbo yield boosting system comprising:
a data collection module;
a memory linked to the data collection module and configured to store a training model;
a processor linked to the memory and configured to perform a Wafer Acceptance Test (WAT) importance analysis module and the training model;
wherein the data collection module acquires a plurality of WAT parameters from a foundry, the data collection module acquires a CPU turbo yield from a final test (FT) stage, the training model generates a predicted CPU turbo yield for the plurality of WAT parameters based on the plurality of WAT parameters and the CPU turbo yield, the training model generates a plurality of importance values corresponding to the plurality of WAT parameters based on the predicted CPU turbo yield and the plurality of WAT parameters, and the training model and the WAT importance analysis module are integrated into an explainable Artificial Intelligence (AI) framework.

12. The system of claim 11, wherein the plurality of WAT parameters comprise saturation current parameters, off-current parameters, threshold voltage parameters, effective capacitance parameters, ring oscillator speed parameters, quiescent current parameters, sheet resistance parameters, and/or contact resistance parameters.

13. The system of claim 11, wherein the training model is an eXtreme Gradient Boosting (XGBoost) model, the XGBoost model comprises a plurality of classifiers, the plurality of classifiers are linked in series and configured to receive the plurality of WAT parameters and the CPU turbo yield.

14. The system of claim 13, wherein the XGBoost model acquires k-th stage data comprising a plurality of data points representing samples of wafers with a high CPU turbo yield and a low CPU turbo yield, the k-th stage data is inputted to a k-th classifier of the XGBoost model, and the k-th classifier classifies the plurality data points of the k-th stage data into a high CPU turbo yield set and a low CPU turbo yield set based on the plurality of WAT parameters and the CPU turbo yield.

15. The system of claim 14, wherein the XGBoost model adjusts weightings of at least one misclassified data point of the k-th stage data to generate (k+1)th stage data, the (k+1)th stage data is inputted to a (k+1)th classifier of the XGBoost model, and the k-th classifier is linked to the (k+1)th classifier.

16. The system of claim 15, wherein the XGBoost model outputs the predicted CPU turbo yield based on last stage data when an amount of misclassified data points of the last stage data is smaller than a threshold, and the threshold is set to determine whether the XGBoost model is fully trained.

17. The system of claim 11, wherein the training model is an extreme Gradient Boosting (XGBoost) model, a light Gradient Boosting Machine (LightGBM) model, a categorical boosting (CatBoost) model, or a random forest model.

18. The system of claim 11, wherein the WAT importance analysis module is a Shapley Additive Explanations (SHAP) module, the WAT importance analysis module acquires a base rate of the CPU turbo yield, the WAT importance analysis module receives the plurality of WAT parameters and the predicted CPU turbo yield, the WAT importance analysis module generates a gap rate between the predicted CPU turbo yield and the base rate of the CPU turbo yield, and the base rate of the CPU turbo yield is an average CPU turbo yield for all testing wafers of the foundry.

19. The system of claim 18, wherein the WAT importance analysis module analyzes the gap rate and features of the plurality of WAT parameters to generate the plurality of importance values corresponding to the plurality of WAT parameters, and the plurality of importance values are used to quantify contributions of the WAT parameters to the CPU turbo yield.

20. The system of claim 11, wherein a WAT parameter having a highest importance value is selected from the plurality of WAT parameters after the plurality of WAT parameters are ranked, and the WAT parameter having the highest importance value is adjusted to boost the CPU turbo yield.
